(19) United States
(12) Patent Application Publication
(10) Pub. No.: US 2018/0153106 A1
(43) Pub. Date: Jun. 7, 2018

(54) Method for Producing Food-Safe Sprouted Seed Products

(71) Applicants: Amogh Ambardekar, St. Louis, MO (US); Nicholas Bruns, Forsyth, MO (US); Brent L. Petersen, Twin Falls, ID (US)

(72) Inventors: Amogh Ambardekar, St. Louis, MO (US); Nicholas Bruns, Forsyth, MO (US); Brent L. Petersen, Twin Falls, ID (US)

(21) Appl. No.: 15/832,758

(22) Filed: Dec. 5, 2017

Related U.S. Application Data
(60) Provisional application No. 62/430,332, filed on Dec. 5, 2016.

(51) Int. Cl. A01G 7/06; A23L 25/00

(52) U.S. Cl. CPC A01G 7/06; A23L 25/20; A23Y 2240/75; A23Y 2220/15; A23Y 2220/67; A23V 2002/00

(57) ABSTRACT

Disclosed is a method for producing a food-safe dried sprouted seed product, which is especially useful for producing dried sprouted grain and oil seed products. The method results in the reduction or elimination of pathogenic microorganisms in the sprouted seed product and/or powdered seed products produced therefrom.

### FIELD OF THE INVENTION

The invention relates to sprouted-seed products and methods for making sprouted seed products. More specifically, the invention relates to methods for producing safer sprouted-seed products by reducing and/or eliminating pathogenic bacteria in those products.

### BACKGROUND OF THE INVENTION

Seed-sprouting enhances the nutritional and functional value of grains and other seeds by increasing some of the beneficial biochemical activities that take place during the process of germination. For example, during the sprouting process there is an increase in activity of enzymes such as those that reduce the binding capacity of “anti-nutrients” such as phytic acid. This increases bioavailability of minerals and vitamins, as well as improving digestibility of protein.

However, sprouts have been associated with a number of outbreaks of foodborne illness related to pathogenic microorganisms. The United States Centers for Disease Control (CDC) has reported outbreaks of foodborne illnesses caused by Salmonella, Listeria and E. coli as the result of consumption of sprouted-food products, and most of the outbreaks have involved consumption of sprouted grains and oilseeds. According to the European Food Safety Authority (EFSA), since seeds used for sprouting are usually stored longer than those used for growing fruits and vegetables, possibly exposing them to dust, contaminated water and/or animal feces for longer periods of time, sprouts have increased potential for contamination by harmful bacteria. Bacteria that contaminate the seed phase can survive for at least 56 weeks, and sprouts can also become contaminated by irrigation water, contaminated human hands, or a variety of other environmental sources during the growing and/or processing phase.

The U.S. Food and Drug Administration (FDA) has recommended that sprout seeds be treated with calcium hypochlorite to reduce microbial contamination. However, calcium hypochlorite is used to disinfect drinking water and sanitize public swimming pools. An oxidizing agent, it presents certain challenges in terms of safe handling and storage. Furthermore, powerful oxidizing agents such as CaOCl and peroxy-acetic acids may destroy nutrients and induce rancidity in omega-3 rich seeds such as flax, chia and quinoa. At present, the best option for treatment of sprouted grains are heat treatments such as the MicroSure™ Plus method (Glanbia Nutritionals, Inc.), a validated 5-log kill process. What are needed are additional and new methods for producing food-safe sprouted grain and seed products.

### SUMMARY OF THE INVENTION

The invention relates to a method for reducing the number of microbes (e.g., bacteria) in a sprouted-seed product, the method comprising stimulating at least one mucilaginous seed to produce mucilage and adding to the mucilaginous seed at least one probiotic microorganism to utilize the mucilage to promote fermentation of the at least one mucilaginous seed during a seed sprouting process to produce at least one sprouted seed product, thereby producing a reduction in the number of microbes present in the resulting sprouted seed product. In various aspects, the method further comprises an additional step comprising drying the sprouted seed product. In various aspects, the dried sprouted seed product is ground, milled, or otherwise comminuted to produce a powder of desired particle size.

In various aspects of the method, the step of stimulating the at least one mucilaginous seed to produce mucilage comprises adding a sufficient quantity of water to the at least one mucilaginous seed to promote mucilage production. In various aspects, the step of stimulating the at least one mucilaginous seed to produce mucilage comprises adding water to the at least one mucilaginous seed to provide a solution of at least about 10 percent seed, by weight. In various aspects, the seed solution is from about 10 percent to about 20 percent seed, by weight. And, in various aspects, the seed solution can be from about 15 percent to about 20 percent seed, by weight.

In various embodiments of the method, the at least one probiotic microorganism is from at least one probiotic bacterial species. In various embodiments, the at least one bacterial species comprises lactic acid bacteria. In various embodiments of the method, the at least one lactic acid bacteria comprises at least one bacteria from at least one genus selected from the group consisting of Lactobacillus, Streptococcus, Bifidobacterium, Leuconostoc Lactobacillus, and combinations thereof.

The invention also relates to a method for modifying the pH and rate of fermentation of a sprouted seed product, the method comprising adjusting the amount of water added to at least one mucilaginous seed to vary the amount of mucilage produced prior to initiating a fermentation process. In various aspects, the step of initiating a fermentation process comprises adding to the mucilaginous seed at least one probiotic microorganism to utilize the mucilage to promote fermentation of the at least one mucilaginous seed during a seed sprouting process.

### BRIEF DESCRIPTION OF THE DRAWINGS

FIG. 1 is a graph illustrating the reduction in pH that occurs during the sprouting-fermenting of flaxseeds over a period of 30 hours.

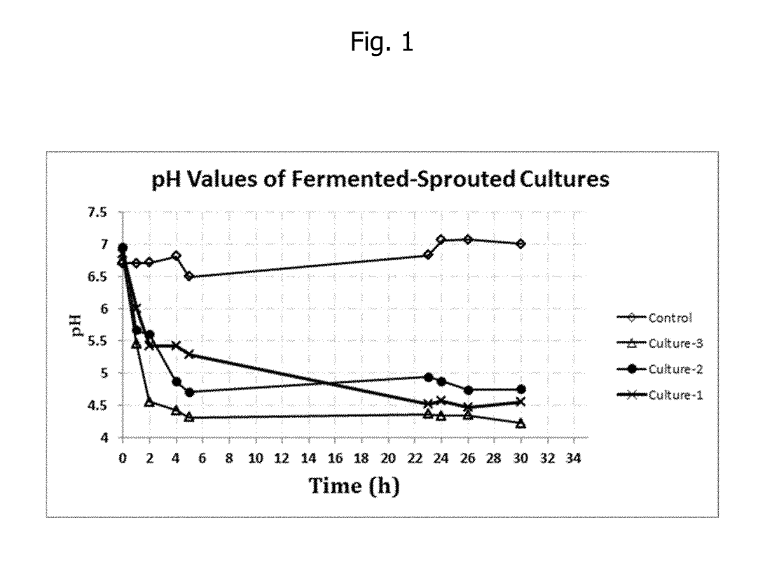

FIG. 2 is a graph illustrating the decrease in viscosity (expressed as a function of shear stress and shear rate) produced by fermentation/sprouting using Culture-1 (a frozen dairy-based blend of Lactobacillus delbruekii bulgaricus and Streptococcus thermophiles), Culture-2 (a freeze-dried non-dairy based culture of Lactobacillus planetarium), as compared to Control (flaxseed sprouted without added bacterial inoculum).

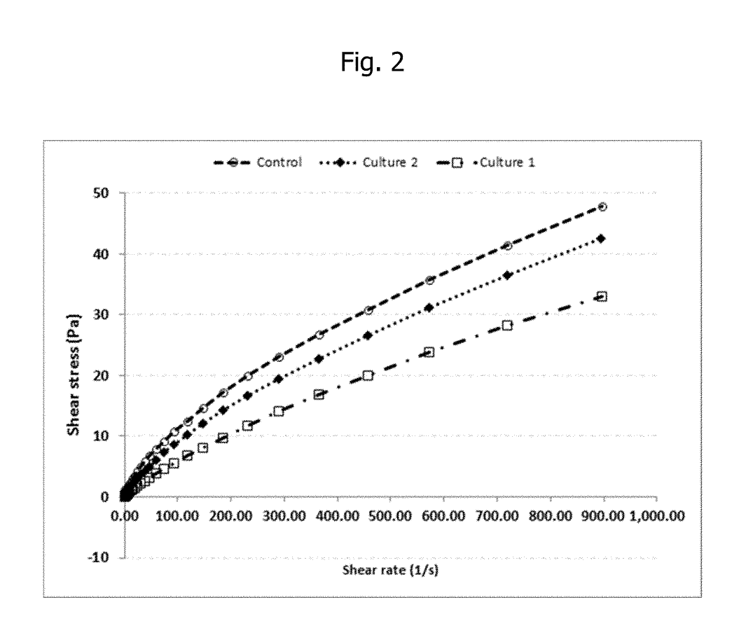

### DETAILED DESCRIPTION

The inventors have produced safer sprouted-seed products by simultaneously, or concurrently, fermenting and sprouting grains and/or oilseeds, using probiotic bacteria (e.g., lactic acid bacterial cultures) during the soaking and incubation stages of sprouting, to significantly reduce the microbial population that may be present in the grains and/or oilseeds and which may contain pathogenic bacteria among the bacteria in that population. To promote fermentation, they have utilized the carbohydrates available in mucilaginous seeds such as flaxseeds, chia seeds, etc.

Fermented food products such as dairy products, bakery products, and beverages are popular in various parts of the world. Natural microbial fermentation using lactic acid bacteria species has been traditionally utilized in dairy and baking applications. These microbes can metabolize carbohydrates available in a dairy or bakery product and convert it to acid (e.g., lactic and/or acetic acid), reducing the pH to <4.5. The lower pH favors growth of desirable lactic acid bacteria, while creating unfavorable growing conditions for pathogenic microbes. Overall, the decrease in pathogenic microbes can generally be detected as a decrease in overall plate counts, decreased microbial load, etc. An added benefit is provided by the lactic acid-producing bacteria in that they produce anti-microbial substances that also may effectively inhibit the growth of undesirable pathogenic microbes in the product.

Flaxseeds (from Linum usitatissimum) and chia seeds (from Salvia hispanica) can be sprouted and further processed to produce sprouted seed powder. This powder can be a good source of fiber, calcium, and other nutrients. However, these products are also prone to contamination by pathogenic bacteria. For example, in February 2016 the United States FDA announced a recall of sprouted flaxseed and chia seed powders that were potentially contamination with Salmonella.

According to Foglein (US 2009/0155397 A1), flaxseed mucilage contains “a lot of materials hindering the digestion,” and “the removal of mucilage should be very desirable to ensure better digestion and absorption.” Salminen et al. (US 2010/0203194 A1) demonstrated that enzymes were not effective in decreasing the viscosity caused by mucilage, and the seed suspension remained viscous and slimy. Their solution was to dilute the seed with a sufficient quantity of water to reduce the viscosity. However, the inventors have found that significant mucilage production and associated viscosity can actually be quite beneficial for promoting the growth of probiotic bacteria and sprouted seed fermentation produced by those bacteria, and they have used it to promote seed fermentation during the sprouting process when probiotic bacteria are added to the seeds. Furthermore, some investigators have reported that flaxseed mucilage, for example, promotes the growth of beneficial bacteria in the human intestine and improves insulin sensitivity (Brahe, L. K. et al. Dietary modulation of the gut microbiota—a randomised controlled trial in obese postmenopausal women. Br J Nutr. 2015 Aug. 14; 114(3): 406-417). Therefore, retaining the mucilage but reducing its viscosity can result in a dried sprouted seed product that could provide additional health benefits to the consumer. The inventors have discovered that fermenting the seed(s) in association with the sprouting process can promote sprouting without promoting the growth of pathogenic bacteria, with the added benefit of providing a significant reduction in mucilage viscosity. Reducing viscosity in this way eliminates the need to reduce the amount of, dilute sufficiently, or eliminate, mucilage from the seed sprouts before processing. For example, in one batch tested for soluble fiber content (mucilage being soluble fiber) in non-fermented-sprouted and fermented-sprouted flaxseed, the inventors noted a reduction of approximately 39 percent in the soluble fiber (comprising mucilage) in the fermented-sprouted flax as compared to the non-fermented-sprouted flaxseed. (The non-fermented, sprouted flaxseed contained 9.6% soluble fiber, while the fermented, sprouted flaxseed contained 5.83% soluble fiber.) So, the viscosity (which can be expressed as a percentage) can be significantly decreased by combining the fermentation and sprouting processes. The mucilage produced by the seeds can therefore be co-dried with the fermented seed sprouts, the combination of probiotic bacteria, mucilage, and fermentation synergistically producing a significant reduction, or a total elimination, of pathogenic bacteria that may be associated with the seeds from which the sprouts are produced.

“Producing” mucilage refers to the release of mucilage from the seed into the surrounding environment. For seeds which can produce significant amounts of mucilage, this can be promoted by a combination of factors, with hydration appearing to be the most important factor, based on the inventors' experiments. “Probiotic” microorganisms, including probiotic bacteria, are known to those of skill in the art as those that promote good health, and often promote the growth of other beneficial microorganisms. “Lactic acid bacteria” are those bacteria that produce lactic/acetic acid via the fermentation of sugars. The production of acid can produce a corresponding decrease in pH in the environment around the bacteria. “Simultaneously” means “concurrently” (within the same general time frame), although it is not necessary that both processes be initiated and/or completed at the same time.

The invention also provides a method for modifying the pH of a fermented sprouted seed product, the method comprising adjusting the amount of water added to at least one mucilaginous seed to vary the concentration of mucilage in a fermentation solution. In various aspects, the method further comprises a step of initiating a fermentation process using the fermentation solution by adding at least one probiotic microorganism to the fermentation solution to promote fermentation of the at least one mucilaginous seed during a seed sprouting process. The inventors have discovered that the pH can be correlated with the percentage of mucilage available to the bacteria in the solution. For example, in one experiment a solution of 20% mucilage produced a pH of less than 4.5 after a 30-hour fermentation period, while the pH remained at greater than or equal to 5.0 in a 10% mucilage solution over the same 30-hour fermentation period. One of skill in the art will recognize that lowering the pH has an inhibitory effect on potentially pathogenic bacteria, for example. One of skill in the art, however, will also recognize that fermentation conditions and optimum mucilage concentration can vary according to the type of seed used and the bacterial inoculum used to promote fermentation. These conditions, however, can readily be determined by those of skill in the art of food processing and/or microbiology without undue experimentation, with the benefit of the information provided herein. Therefore, the invention also encompasses solutions which contain an effective amount of mucilage to result in a decrease in pH, to achieve a pH of less than or equal to about 4.5. Generally, the desired pH will not be higher than about 4.5, in order to achieve a pH that will be inhibitory to potentially pathogenic microorganisms.

Mucilage in flaxseed, for example, represents 23% of the seed and is found in the seed coat. It is water-soluble, although in sufficient concentration it tends to become gelatinous, or viscous, in water. It is categorized as a “soluble fiber.” Mucilage is rich in a variety of simple sugars such as xylose, arabinose, rhamnose, rhamnose, galactose, glucose, mannose, and fucose, with the amount and type varying in different types of plants and seeds. As is commonly known to those of skill in the art, many bacteria utilize sugars such as glucose as a food source, which can promote fermentation by those bacteria. Some lactic acid bacteria, such as Lactobacillus pentosus, Lactobacillus brevis, Lactobacillus plantarum, and Leuconostoc lactis, are known to ferment either arabinose or xylose, or both. In these microorganisms, arabinose is converted to xylulose-5-phosphate (X5P) by arabinose isomerase (AraA), ribulokinase (AraB), and ribulose 5-phosphate 4-epimerase (AraD). X5P is converted to equimolar amounts of lactic acid and acetic acid.

Fermenting and sprouting have been used to produce beverages made from sprouted grains, such as “rejuvelac”—a non-alcoholic fermented drink. However, part of the process for making those products involves straining out the sprouted seeds and discarding them. Also, the goal, when producing these drinks, is to produce something that many have described as “like lemonade,” rather than a viscous solution such as that produced by mucilaginous seeds. The drink is generally made with two ingredients—seeds and water. Contamination appears to be a somewhat common occurrence, as many blogs and other websites that promote the product and provide instructions for making it caution against drinking it if it has a particularly unpleasant smell, indicating that it has been contaminated.

The present invention utilizes the combination of fermentation and sprouting to decrease the number of microbes that might otherwise have reproduced in the sprouted seed composition to a level that could prove dangerous to health—or even deadly. To promote both processes, mucilage production is stimulated and probiotic bacteria are added to the sprouting seed composition. Mucilage provides a significant benefit by supporting bacterial metabolism and production of lactic and/or acetic acid, and may have its own inhibitory effects on pathogenic bacteria in addition to that supportive role. Probiotic bacteria create an environment that inhibits the growth of pathogenic bacteria, and they may also produce metabolic products that are directly inhibitory, as well. However, mucilage production is also known to make flaxseed processing significantly more difficult. Bacteria have been reported to increase the viscosity of some of their growth media, and have been reported to decrease the viscosity of some other growth media. In the present case, the lactic acid bacteria have demonstrated the ability to decrease the viscosity of the mucilage in the sprouting seed composition, making it easier to process by means such as drying and grinding, milling, or otherwise reducing to a powder. By combining these elements, the inventors have achieved a significant reduction in microbial load, as shown in Table 1 below, as well as a significant decrease in composition viscosity, allowing one of skill in the art to produce safer sprouted seed products which can be more easily processed using methods such as drying, grinding, milling, etc. In addition to these advantages, the inventive method produces a product that provides a combination of beneficial nutrients from both the seed and the mucilaginous extract from the seed. The invention therefore includes not only the method, but also sprouted seed products produced by the method.

The invention has been described as “comprising” certain steps and ingredients, which those of skill in the art will understand may also be considered to “consist of” or “consist essentially of” those steps and/or ingredients. Therefore, where the term “comprising” is used but the invention is intended to be more narrowly defined, the terms “consisting of” or “consisting essentially of” may also be used to describe the invention. The invention may also be further described by means of the following non-limiting examples.

### EXAMPLES

Raw non-sprouted brown and golden flaxseeds were obtained from flax growers in Canada. Culture-1 (Danisco) was a frozen dairy-based blend of Lactobacillus delbruekii bulgaricus and Streptococcus thermophiles. Culture-2 (Lallemand) was a freeze-dried non-dairy based culture of Lactobacillus planetarium. Culture-3 (YC-X11) was a freeze-dried non-dairy based culture of Lactobacillus acidophilus, L. bulgaricus, L. casaei, L. rhamnosus, Streptococcus thermophiles and Bifidobacterium bifidum. A 20% w/w flaxseed solution was prepared in a stainless steel container. The mixture was stirred using a magnet on a hot plate and the temperature was adjusted to within a range of from about 35° to about 42° C. The mixture was hydrated for 30-minutes for the most possible mucilage generation and to ensure that appropriate temperatures were reached. Each culture (i.e., inoculum) was added to the mixture at 0.1% (w/w) of the mixture. The pH was measured at specific time intervals to quantify the degree of fermentation. The mixture was poured on a flat metal tray and dried in an oven at 131° F. or 55° C. for 72 h. The resulting dried flaxseed was scraped from the tray, producing a product that could be used as whole-seed or crushed or milled to flour. Table 1 lists the aerobic plate counts log reduction, nitrogen solubility, and final pH for each of the three cultures, as well as control (no inoculum added).

TABLE 1
Comparison of Log Reduction in Aerobic Plate Counts (APCs),
Nitrogen Solubility, Final Product pH and Phytic
Acid Levels of Control and Treatments

| | APC Log | N-Solubility | Product | Phytic |
|---|---|---|---|---|
| Inoculum | reduction | at pH 4 | pH | Acid |
| Control (no inoculum) | — | 23% | 6.01 | 1300 |
| Danisco | 4.57 | 59% | 4.23 | Not tested |
| (Lactic Acid Bacteria | | | | |
| Blend) | | | | |
| Lallemand L4K | 3.26 | 46% | 4.52 | 950 |
| (Lactic Acid Bacteria, | | | | |
| Yeast) | | | | |
| YC-X11 | 3.13 | 54% | 4.5 | 935 |
| (L. bulgaricus & | | | | |
| S. thermophilus) | | | | |

*APCs for Control = 116,000,000; APCs for Lallemand = 63,000; APCs for YC-X11 = 3,100
**APCs for Control = 55,400,000; APCs for Danisco = 41000

Additional sprouting/fermenting trials were conducted using the method described above, with the results shown in Table 2.

What is claimed is:

1. A method for reducing the number of bacteria in a sprouted-seed product, the method comprising
(a) stimulating at least one mucilaginous seed to produce mucilage; and
(b) adding to the mucilaginous seed at least one probiotic microorganism to promote fermentation of the at least one mucilaginous seed during a sprouting process, thereby producing a reduction in the number of microbes present in a sprouted seed product produced by the sprouting process.

2. The method of claim 1 wherein the mucilaginous seed is a raw, non-sprouted mucilaginous seed.

3. The method of claim 1, further comprising the step of drying the sprouted seed product.

4. The method of claim 1, further comprising steps
(c) drying the sprouted seed product; and
(d) comminuting the dried sprouted seed product to produce a powdered sprouted seed product.

5. The method of claim 1, wherein the step of stimulating the at least one mucilaginous seed to produce mucilage comprises adding a sufficient quantity of water to the at least one mucilaginous seed to promote mucilage production.

6. The method of claim 1, wherein the step of stimulating the at least one mucilaginous seed to produce mucilage comprises adding water to the at least one mucilaginous seed at a ratio of at least about 10 percent seed to water (w/w).

7. The method of claim 1, wherein the step of stimulating the at least one mucilaginous seed to produce mucilage comprises adding water to the at least one mucilaginous seed to produce a solution of from about 10% to about 20% seed-to-water, by weight.

8. The method of claim 1, wherein the step of stimulating the at least one mucilaginous seed to produce mucilage comprises adding water to the at least one mucilaginous seed to produce a solution having an effective amount of mucilage to produce a pH of less than or equal to about 4.5

9. The method of claim 1, wherein the at least one probiotic microorganism is from at least one probiotic bacterial species.

10. The method of claim 1, wherein the at least one probiotic microorganism comprises lactic acid bacteria.

11. The method of claim 1, wherein the at least one probiotic microorganism comprises at least one bacteria from at least one genus selected from the group consisting of Lactobacillus, Streptococcus, Bifidobacterium, and combinations thereof.

12. The method of claim 1, wherein the reduction in the number of microbes present is a reduction in the number of bacteria present.

13. A method for modifying the pH of a fermented sprouted seed product, the method comprising adjusting the amount of water added to at least one mucilaginous seed to vary the concentration of mucilage in a resulting fermentation solution comprising the at least one mucilaginous seed.

14. The method of claim 13 further comprising a step of initiating a fermentation process using the fermentation solution by adding at least one probiotic microorganism to the fermentation solution to promote fermentation of the at least one mucilaginous seed during a seed sprouting process.
